(19) United States
(12) Patent Application Publication
(10) Pub. No.: US 2008/0133036 A1
(43) Pub. Date: Jun. 5, 2008

(54) APPARATUS AND METHOD FOR PLAYBACK TEST

(75) Inventors: AI-MIN CHEN, Shenzhen (CN); XIAO-CHENG GUAN, Shenzhen (CN); XIAO-LIN GAN, Shenzhen (CN); YU-KUANG HO, Taipei Hsien (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Taipei Hsien (TW)

(21) Appl. No.: 11/778,080

(22) Filed: Jul. 16, 2007

(30) Foreign Application Priority Data
Dec. 1, 2006 (CN) 200610157201.8

(51) Int. Cl. G06F 17/00

(52) U.S. Cl. 700/94

(57) ABSTRACT

A method for playback test includes the steps of: controlling an audio analyzer (3) connected to a host computer (2) to generate digital audio signals at different sampling frequencies, different sampling bit width and different signal amplitude, and controlling the audio analyzer to output the digital audio signals to a client computer (5) connected to the audio analyzer; transmitting the digital audio signals to a sound card (7) inside the client computer without data loss; converting the digital audio signals into analog audio signals, and transmitting the analog audio signals to an analog signal input interface (311) of the audio analyzer; and controlling the audio analyzer to test and analyze the analog audio signals, and producing a test result. A related apparatus is also provided.

### BACKGROUND OF THE INVENTION

1. Field of the Invention

The present invention is related to apparatuses and methods for playback test.

2. Description of Related Art

Nowadays, a computer not only assists people in processing data, but it can also be used as a multimedia player that brings music or multimedia presentation to people. An audio device plays an important role in transmitting audio signals within a computer. Before a computer is incased, the computer should pass a series of tests, such as a performance test on transmitting signals of an audio device whereon to make sure that the audio device works normally.

One method in the art for playback test includes several steps of format conversion of audio files. However, this method has more or less disadvantages. For example, partial data of the audio files may be lost in the process of format conversion.

Accordingly, what is needed is a system and method for playback test, which can test audio files without data loss and realize real-time analysis of test results.

### SUMMARY OF THE INVENTION

One preferred embodiment provides an apparatus for playback test. The apparatus includes a host computer, an audio analyzer connected to the host computer, and a client computer connected to the audio analyzer. The host computer is installed with an audio test program for controlling the audio analyzer to generate digital audio signals at different sampling frequencies, different sampling bit width and different signal amplitude, and controlling the audio analyzer to output the digital audio signals to the client computer. The client computer is configured for transmitting the digital audio signals to a sound card without data loss. The sound card is configured for converting the digital audio signals into analog audio signals, and transmitting the analog audio signals to an analog signal input interface of the audio analyzer via an audio output interface of the client computer, and the audio test program controls the audio analyzer to test and analyze the analog audio signals and produce a test result.

Another preferred embodiment provides a method for playback test. The method includes the steps of: controlling an audio analyzer connected to a host computer to generate digital audio signals at different sampling frequencies, different sampling bit width and different signal amplitude, and controlling the audio analyzer to output the digital audio signals to a client computer connected to the audio analyzer; transmitting the digital audio signals to a sound card inside the client computer without data loss; converting the digital audio signals into analog audio signals, and transmitting the analog audio signals to an analog signal input interface of the audio analyzer; and controlling the audio analyzer to test and analyze the analog audio signals, and producing a test result.

Other systems, methods, features, and advantages will be or become apparent to one skilled in the art upon examination of the following drawings and detailed description.

### BRIEF DESCRIPTION OF THE DRAWINGS

FIG. 1 is a schematic diagram of hardware configuration of an apparatus for playback test in accordance with one preferred embodiment;

FIG. 2 is a schematic diagram of hardware configuration of an apparatus for playback test in accordance with another preferred embodiment; and

FIG. 3 is a flowchart of a method for playback test in accordance with one preferred embodiment.

### DETAILED DESCRIPTION OF THE INVENTION

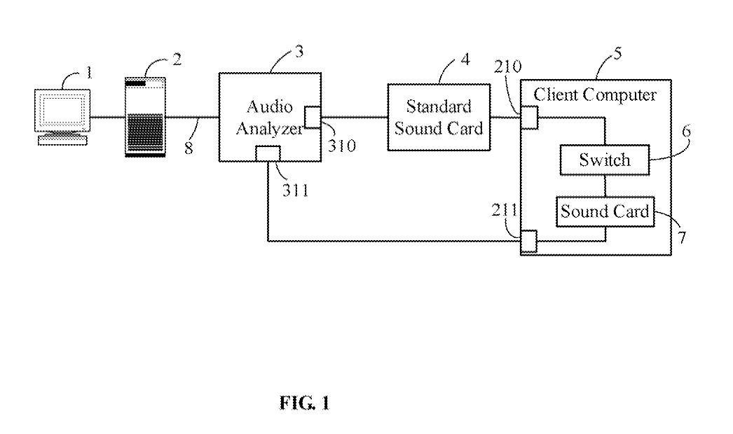

FIG. 1 is a schematic diagram of hardware configuration of an apparatus for playback test in accordance with one preferred embodiment. The apparatus may typically include a host computer 2, a display 1 connected to the host computer 2, an audio analyzer 3, a standard sound card 4, and a client computer 5. The host computer 2 is connected with the audio analyzer 3 via a 3.5 millimeter (mm) splicing ear 8. The host computer 2 is installed with an audio test program that controls the audio analyzer 3 to test and analyze audio signals. The client computer 5 may include a switch 6, a sound card 7, a universal serial bus (USB) interface 210, and an audio output interface 211. The audio analyzer 3 may include a digital signal output interface 310 and an analog signal input interface 311. The audio output interface 211 is connected with the analog signal input interface 311.

The host computer 2 is configured for controlling the audio analyzer 3 to generate digital audio signals at different sampling frequencies, different sampling bit width and different signal amplitude. The host computer 2 is further configured for controlling the audio analyzer 3 to output the digital audio signals to the standard sound card 4 via the digital signal output interface 310.

The standard sound card 4 is configured for converting the digital audio signals into USB digital audio signals receivable by the USB interface 210 of the client computer 5.

The client computer 5 is configured for receiving the USB digital audio signals at the USB interface 210 and transmitting the USB digital audio signals to the sound card 7 without data loss through the switch 6.

The sound card 7 is configured for converting the USB digital audio signals into analog audio signals via a digital to analog conversion circuit of the sound card 7, and transmitting the analog audio signals to the analog signal input interface 311 via the audio output interface 211.

The host computer 2 is further configured for controlling the audio analyzer 3 to test and analyze the analog audio signals received at the audio output interface 211 and for displaying a test result on the display 1. Parameters of testing and analyzing the analog audio signals include full scale output voltage, frequency response, total harmonic distortion plus noise, dynamic range, signal to noise ratio, channel separation, passband ripple, and interchannel phase delay.

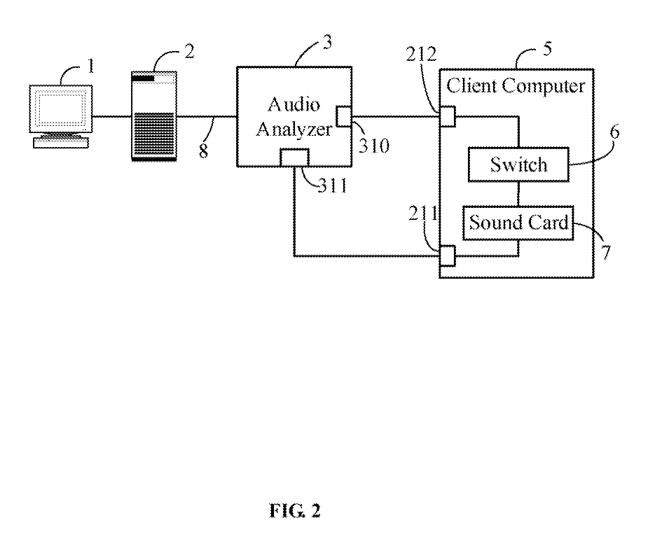

FIG. 2 is a schematic diagram of hardware configuration of an apparatus for playback test in accordance with another preferred embodiment. The client computer 5 may further include a digital audio signal input interface 212 connected to the digital signal output interface 310. The client computer 5 can receive the digital audio signals produced by the audio analyzer 3 via the digital audio signal input interface 212 and the digital signal output interface 310, instead of utilizing the standard sound card 4 in the first embodiment.

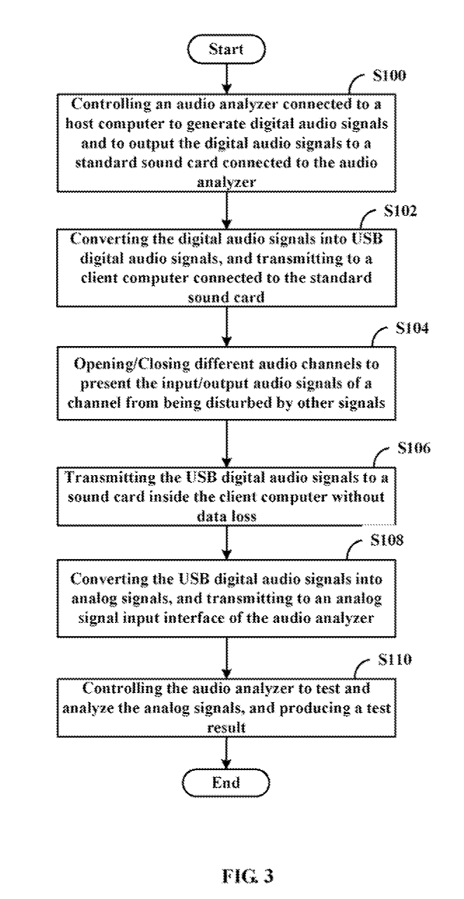

FIG. 3 is a flowchart of a method for playback test in accordance with one preferred embodiment.

In step S100, the host computer 2 controls the audio analyzer 3 to generate the digital audio signals at different sampling frequencies, different sampling bit width and different signal amplitude, and the host computer 2 controls the audio analyzer 3 to output the digital audio signals to the standard sound card 4 via the digital signal output interface 310.

In step S102, the standard sound card 4 converts the digital audio signals into USB digital audio signals, and transmits the USB digital audio signals to the USB interface 210 of the client computer 5.

In step S104, the client computer 5 opens/closes different audio channels to prevent the input/output audio signals of a channel from being disturbed by other signals.

In step S106, the client computer 5 transmits the USB digital audio signals to the sound card 7 without data loss through the switch 6.

In step S108, the sound card 7 converts the USB digital audio signals into analog audio signals via a digital to analog conversion circuit and transmits the analog audio signal to the analog signal input interface 311 via the audio output interface 211.

In step S110, the host computer 2 controls the audio analyzer 3 to test and analyze the analog audio signals received at the audio output interface 211 and displays a test result on the display 1.

In an alternative embodiment, in the step S100, the host computer 2 controls the audio analyzer 3 to output the digital audio signals to the digital audio signal input interface 212, and the procedure goes to step S104 directly.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. An apparatus for playback test, comprising a host computer, an audio analyzer connected to the host computer, and a client computer connected to the audio analyzer, wherein:
the host computer is installed with an audio test program for controlling the audio analyzer to generate digital audio signals at different sampling frequencies, different sampling bit width and different signal amplitude, and controlling the audio analyzer to output the digital audio signals to the client computer;
the client computer is configured for transmitting the digital audio signals to a sound card without data loss; and
the sound card is configured for converting the digital audio signals into analog audio signals, and transmitting the analog audio signals to an analog signal input interface of the audio analyzer via an audio output interface of the client computer, wherein the audio test program controls the audio analyzer to test and analyze the analog audio signals and produce a test result.

2. The apparatus according to claim 1, further comprising a display device connected to the host computer for displaying the test result.

3. The apparatus according to claim 1, wherein the audio analyzer is connected with a universal serial bus (USB) interface of the client computer via a standard sound card.

4. The apparatus according to claim 3, wherein the standard sound card is configured for converting the digital audio signals into USB digital audio signals to be received by the USB interface.

5. The apparatus according to claim 1, wherein the audio analyzer is connected to a digital audio signal input interface of the client computer directly.

6. A method for playback test, the method comprising the steps of: controlling an audio analyzer connected to a host computer to generate digital audio signals at different sampling frequencies, different sampling bit width and different signal amplitude, and controlling the audio analyzer to output the digital audio signals to a client computer connected to the audio analyzer;
transmitting the digital audio signals to a sound card inside the client computer without data loss;
converting the digital audio signals into analog audio signals, and transmitting the analog audio signals to an analog signal input interface of the audio analyzer; and
controlling the audio analyzer to test and analyze the analog audio signals, and producing a test result.

7. The method according to claim 6, wherein the content of testing and analyzing the analog audio signals includes full scale output voltage, frequency response, total harmonic distortion plus noise, dynamic range, signal to noise ratio, channel separation, passband ripple, and interchannel phase delay.

8. The method according to claim 6, wherein the audio analyzer is connected with a universal serial bus (USB) interface of the client computer via a standard sound card.

9. The method according to claim 8, further comprising the step of converting the digital audio signals into USB digital audio signals to be received by a USB interface of the client computer.

10. The method according to claim 6, wherein the audio analyzer is connected to a digital audio signal input interface of the client computer directly.
